(19) United States
(12) Patent Application Publication
(10) Pub. No.: US 2012/0238217 A1
(43) Pub. Date: Sep. 20, 2012

(54) WIRELESS COMMUNICATION APPARATUS, WIRELESS COMMUNICATION SYSTEM, AND SENSITIVITY ADJUSTMENT METHOD

(75) Inventor: Yasuhiko Otani, Tokyo (JP)

(73) Assignee: SONY CORPORATION, Tokyo (JP)

(21) Appl. No.: 13/413,900

(22) Filed: Mar. 7, 2012

(30) Foreign Application Priority Data
Mar. 17, 2011 (JP) 2011-058985

(51) Int. Cl. H04B 15/00; H04W 4/00; H04W 88/02

(52) U.S. Cl. 455/63.1; 455/73; 455/77

(57) ABSTRACT

Provided is a wireless communication apparatus including a filter for removing a signal whose strength is below a threshold, a signal distinguishing unit for distinguishing between a non-interfering signal that is transmitted/received in a network that the wireless communication apparatus is connected to and an interfering signal that is transmitted/received in a network that the wireless communication apparatus is not connected to, and a threshold adjustment unit for raising, in a case an interfering signal passed through the filter, the threshold to a level that causes the interfering signal to be removed by the filter.

### CROSS-REFERENCE TO RELATED APPLICATION

The present application claims priority from Japanese Patent Application No. JP 2011-058985 filed in the Japanese Patent Office on Mar. 17, 2011, the entire content of which is incorporated herein by reference.

### BACKGROUND

The present disclosure relates to a wireless communication apparatus, a wireless communication system, and a sensitivity adjustment method.

A technology for streaming data such as video, audio, or the like is widely used. Also, wireless networks are becoming spread into ordinary households. Thus, a technology of transmitting data such as video, audio or the like which has been streamed to a reproduction device is gaining attention. However, to wirelessly transmit, with no interruption, data that is continuously supplied is difficult. For example, in the case of using a wireless network that is based on IEEE 802.11, if an interfering radio wave of a strength exceeding a carrier sense level is received, control of reception timing based on CSMA/CA is implemented, and reception of data is interrupted. Additionally, JP-H9-191311A and JP-2009-193176A disclose technologies of automatically adjusting a receiving sensitivity level to remove external noise or a signal that is not interpretable.

### SUMMARY

However, even if the technologies of JP-H9-191311A and JP-2009-193176A are used, it is difficult to remove interpretable data exchanged in a nearby wireless network as the interfering radio wave. Thus, the present technology has been devised in view of the above circumstance, and it is intended to provide a wireless communication apparatus, a wireless communication system, and a sensitivity adjustment method which are novel and improved, and which are capable of preventing interruption of continuous reception of a non-interfering signal due to control of a reception timing in response to an interfering signal.

According to an embodiment of the present disclosure, there is provided a wireless communication apparatus which includes a filter for removing a signal whose strength is below a threshold, a signal distinguishing unit for distinguishing between a non-interfering signal that is transmitted/received in a network that the wireless communication apparatus is connected to and an interfering signal that is transmitted/received in a network that the wireless communication apparatus is not connected to, and a threshold adjustment unit for raising, in a case an interfering signal passed through the filter, the threshold to a level that causes the interfering signal to be removed by the filter.

The wireless communication apparatus may further include a signal transmission unit for transmitting, after adjustment of the threshold by the threshold adjustment unit, a signal to one or more other wireless communication apparatuses in the network that the wireless communication apparatus is connected to, a signal reception unit for receiving a response signal transmitted from the one or more other wireless communication apparatuses in response to the signal transmitted by the signal transmission unit, and a reception period prediction unit for predicting a period in which the response signal will be received by the signal reception unit. In this case, the threshold adjustment unit temporarily lowers the threshold only during the period predicted by the reception period prediction unit.

The wireless communication apparatus may further include a signal request unit for requesting, after adjustment of the threshold by the threshold adjustment unit, one or more other wireless communication apparatuses in the network that the wireless communication apparatus is connected to for transmission of a response signal, and a channel change unit for changing a channel in a case the response signal is not received from at least one of the one or more other wireless communication apparatuses after the request by the signal request unit.

The wireless communication apparatus may further include a signal request unit for requesting, after adjustment of the threshold by the threshold adjustment unit, one or more other wireless communication apparatuses in the network that the wireless communication apparatus is connected to for transmission of a response signal. In this case, the threshold adjustment unit lowers the threshold in a case the response signal is not received from at least one of the one or more other wireless communication apparatuses after the request by the signal request unit.

In a case the response signal is not received from at least one of the one or more other wireless communication apparatuses after the request by the signal request unit, the threshold adjustment unit may lower the threshold step by step until the response signal is received from all of the one or more other wireless communication apparatuses.

The wireless communication apparatus may further include an information display unit for displaying identification information for identifying, in a case the response signal is not received from at least one of the one or more other wireless communication apparatuses after the request by the signal request unit, the at least one of the one or more other wireless communication apparatuses from which the response signal is not received.

The non-interfering signal may include at least a video or audio that has been streamed.

According to another embodiment of the present disclosure, there is provided a wireless communication system which includes a first wireless communication apparatus including a first filter for removing a signal whose strength is below a first threshold, a first signal distinguishing unit for distinguishing between a non-interfering signal that is transmitted/received in a network that the first wireless communication apparatus is connected to and an interfering signal that is transmitted/received in a network that the first wireless communication apparatus is not connected to, and a first threshold adjustment unit for raising, in a case an interfering signal passed through the first filter, the first threshold to a level that causes the interfering signal to be removed by the first filter, and a second wireless communication apparatus connected to the first wireless communication apparatus via the network, including a second filter for removing a signal whose strength is below a second threshold, a second signal distinguishing unit for distinguishing between a non-interfering signal that is transmitted/received in the network that the second wireless communication apparatus is connected to and an interfering signal that is transmitted/received in a network that the second wireless communication apparatus is not connected to, and a second threshold adjustment unit for raising, in a case an interfering signal passed through the second filter, the second threshold to a level that causes the interfering signal to be removed by the second filter. The first wireless communication apparatus transmits a non-interfering signal including at least a video or audio that has been streamed, to the second wireless communication apparatus over the network.

According to another embodiment of the present disclosure, there is provided a sensitivity adjustment method performed by a wireless communication apparatus including a filter for removing a signal whose strength is below a threshold, which includes distinguishing between a non-interfering signal that is transmitted/received in a network that the wireless communication apparatus is connected to and an interfering signal that is transmitted/received in a network that the wireless communication apparatus is not connected to, and raising, in a case an interfering signal passed through the filter, the threshold to a level that causes the interfering signal to be removed by the filter.

According to the embodiments of the present disclosure described above, it is possible to prevent interruption of continuous reception of a non-interfering signal due to control of a reception timing in response to an interfering signal.

### BRIEF DESCRIPTION OF THE DRAWINGS

FIG. 1 is an explanatory diagram for describing influence of radio interference;

FIG. 2 is an explanatory diagram showing an example configuration of an audio delivery system;

FIG. 3 is an explanatory diagram showing an example configuration of the audio delivery system;

FIG. 4 is an explanatory diagram showing an example functional configuration of an access point;

FIG. 5 is an explanatory diagram showing an example functional configuration of an audio output device;

FIG. 6 is an explanatory diagram showing an example functional configuration of an audio reproduction device;

FIG. 7 is an explanatory diagram showing an example functional configuration of a wireless processing unit according to the embodiment;

FIG. 8 is an explanatory diagram for describing a sensitivity adjustment method according to the embodiment;

FIG. 9 is an explanatory diagram for describing the sensitivity adjustment method according to the embodiment;

FIG. 10 is an explanatory diagram for describing the sensitivity adjustment method according to the embodiment;

FIG. 11 is an explanatory diagram for describing the sensitivity adjustment method according to the embodiment;

FIG. 12 is an explanatory diagram for describing the sensitivity adjustment method according to the embodiment (modified example #1);

FIG. 13 is an explanatory diagram for describing the sensitivity adjustment method according to the embodiment (modified example #1);

FIG. 14 is an explanatory diagram for describing the sensitivity adjustment method according to the embodiment (modified example #2);

FIG. 15 is an explanatory diagram for describing the sensitivity adjustment method according to the embodiment (modified example #2);

FIG. 16 is an explanatory diagram for describing a sensitivity adjustment method according to the embodiment;

FIG. 17 is an explanatory diagram for describing the sensitivity adjustment method according to the embodiment; and

FIG. 18 is an explanatory diagram for describing the sensitivity adjustment method according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

### [Flow of Description]

The flow of a description given below will now be briefly stated.

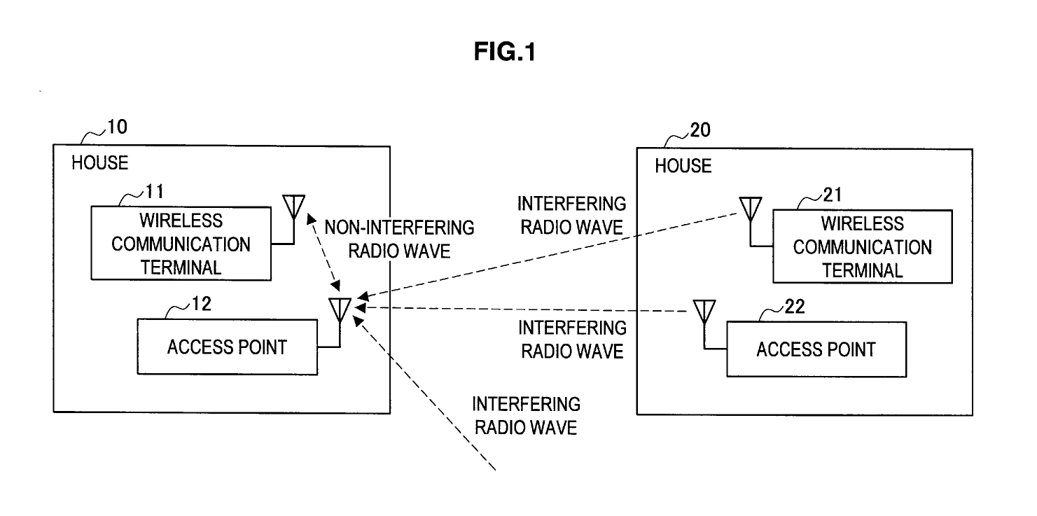

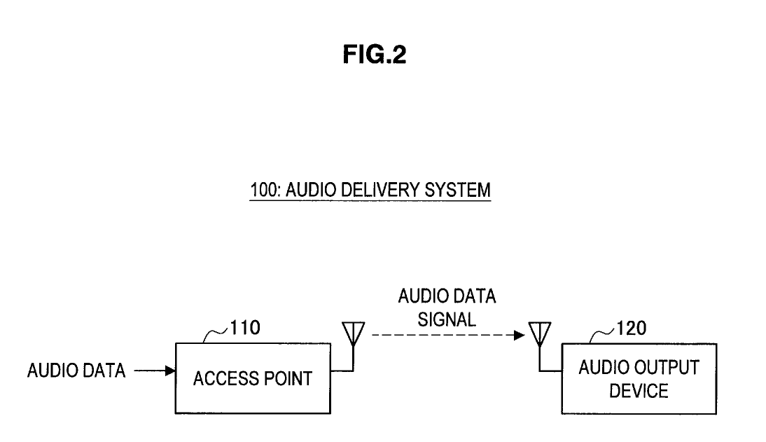

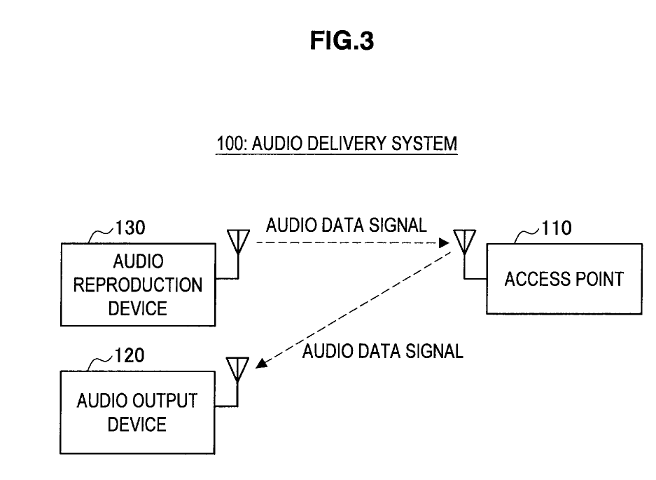

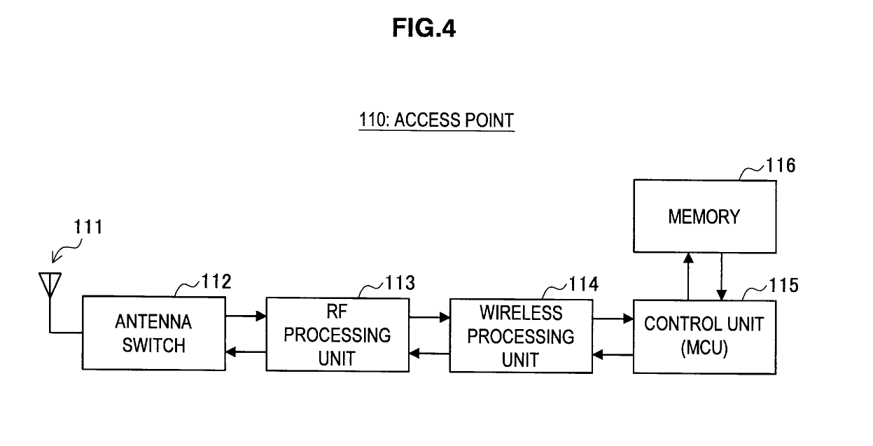

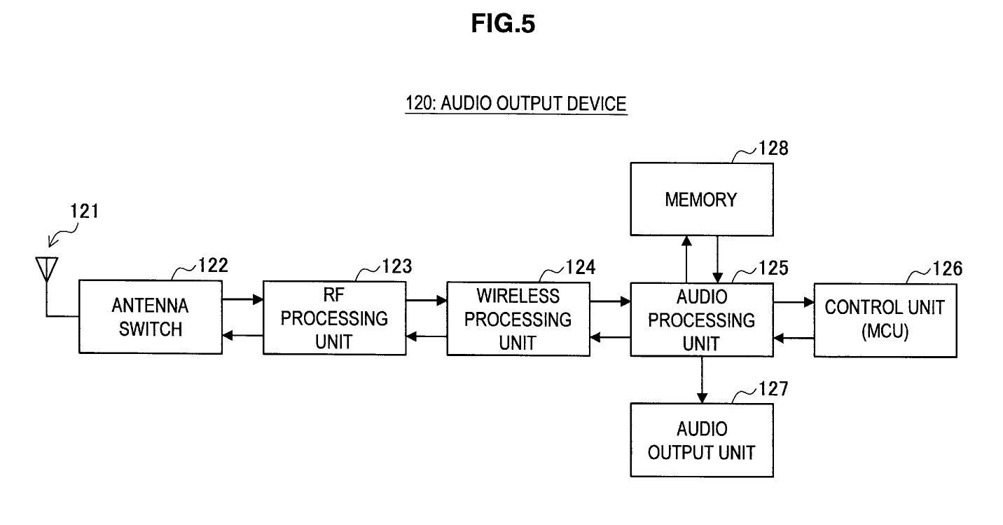

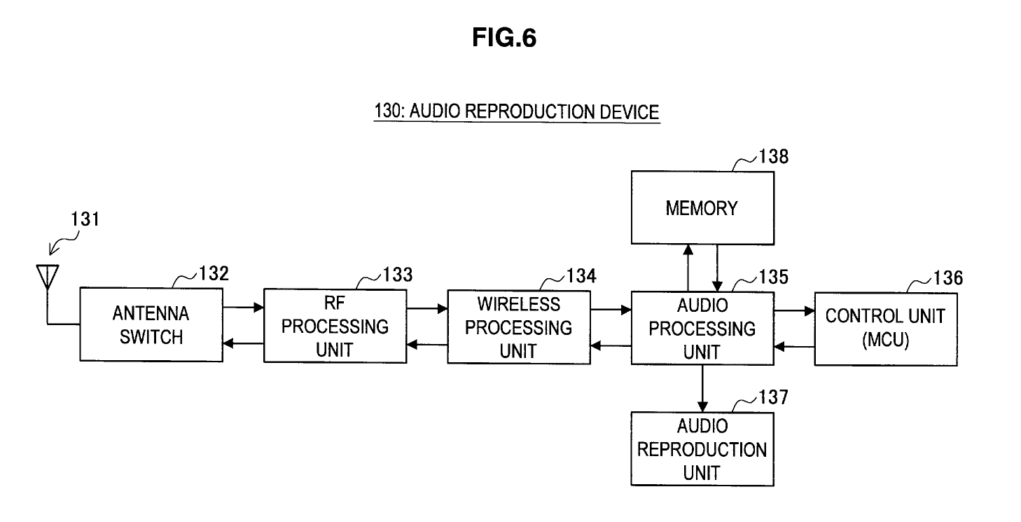

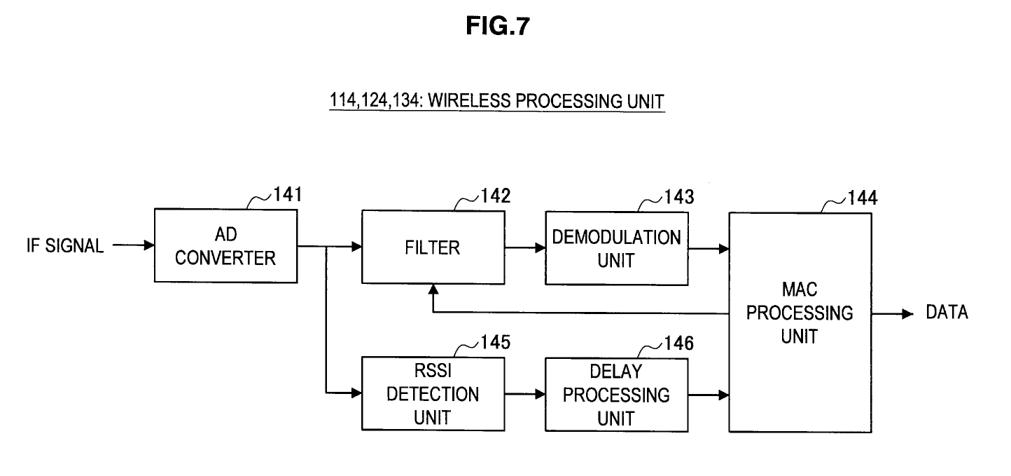

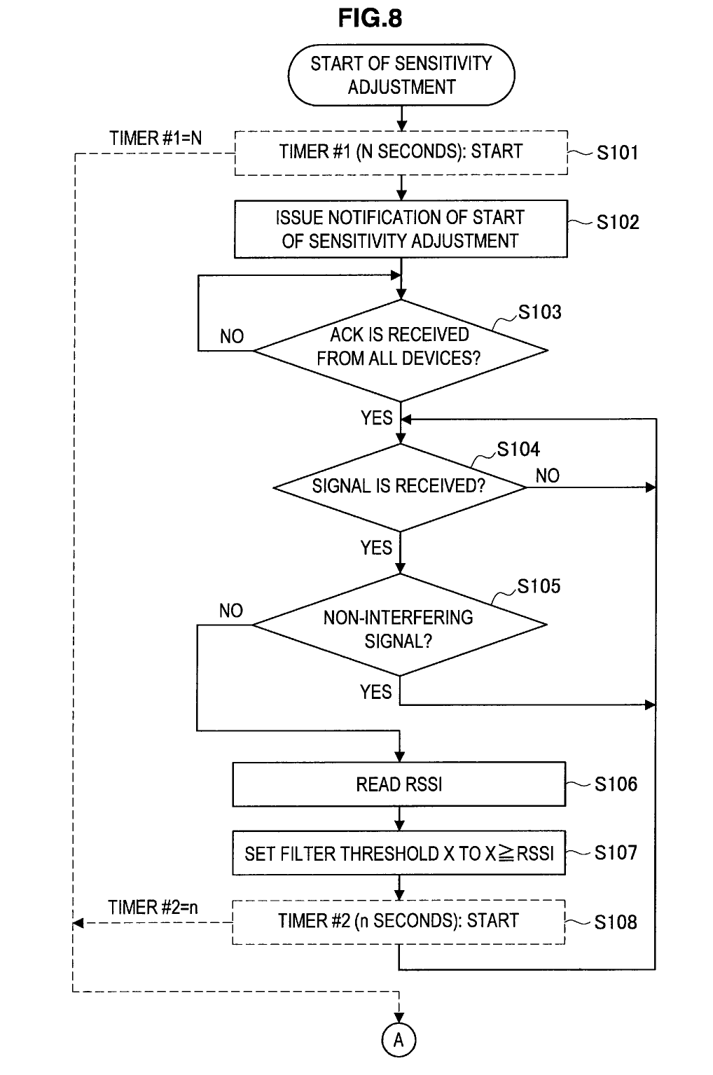

First, influence of radio interference will be described with reference to FIG. 1. Then, example configurations of an audio delivery system 100 will be described with reference to FIGS. 2 and 3. Then, an example configuration of an access point 110 will be described with reference to FIG. 4. Then, an example configuration of an audio output device 120 will be described with reference to FIG. 5. Then, an example configuration of an audio reproduction device 130 will be described with reference to FIG. 6. Then, an example configuration of a wireless processing unit (114, 124, 134) will be described with reference to FIG. 7. Then, a sensitivity adjustment method according to the embodiment will be described with reference to FIGS. 8 to 18.

Lastly, technical ideas of the embodiment will be summarized and effects obtained by the technical ideas will be briefly described.

(Explanation Items)

1: Introduction
1-1: Influence of Radio Interference
1-2: Example Configuration of Audio Delivery System 100
   1-2-1: System Configuration
   1-2-2: Example Configuration of Access Point 110
   1-2-3: Example Configuration of Audio Output Device 120
   1-2-4: Example Configuration of Audio Reproduction Device 130 1-3: Streaming

2: Embodiment
2-1: Example Configuration of Wireless Processing Units 114, 124, 134
2-2: Sensitivity Adjustment Method (Case of Access Point 110)
   2-2-1: Basic Configuration
   2-2-2: Modified Example #1 (Channel Change)
   2-2-3: Modified Example #2 (Step-by-Step Reduction in Sensitivity)
2-3: Sensitivity Adjustment Method (Case of Terminal)
2-4: Configuration for Secure Reception of ACK

3: Summary

### 1: Introduction

First, influence exerted by radio interference on streaming in a situation where data such as audio, video, or the like is streamed over a wireless network will be described. Additionally, in the following description, a wireless LAN (Local Area Network) will be taken as an example of the wireless network. Also, audio data will be taken as an example of the data to be streamed. Of course, the following can be said also for streaming of video data.

### 1-1: Influence of Radio Interference

As a new use of a wireless LAN, transmission at home over the wireless LAN of data such as audio, video, or the like which has been streamed is being considered. Until now, improvements have been made on the technology of the wireless LAN to increase a communication distance or to increase a throughput, even if only slightly. For example, with respect to a method of adjusting receiving sensitivity, technological improvements have been made to increase the receiving sensitivity to increase the communication distance, even if only slightly. On the other hand, an unnecessary interfering radio wave is received due to the increase in the receiving sensitivity, and thus technological improvements have been made to remove such an unnecessary interfering radio wave.

In an environment where an interfering radio wave can be ignored, increase in the receiving sensitivity directly results in the increase in performance. On the other hand, in an environment where a large number of radio waves for the wireless LAN are exchanged, such as a densely-populated area, frequency of interference increases, resulting in poor connection or decrease in the throughput. For this reason, the receiving sensitivity is preferably set as appropriate according to the environment or the use. Now, what level of receiving sensitivity is preferable to transmit, at home over the wireless LAN, audio data that is being streamed? Let us consider this point a little.

In the case of streaming audio data at home over the wireless LAN, what is necessary for wireless transmission of the audio data is that appliances connected to a network used for the wireless transmission of the audio data can perform smooth communication. That is, sufficient throughput has to be obtained between the appliances connected to a home network, and the audio data has to be wirelessly transmitted without being interrupted. Accordingly, the distance between the appliances connected to a home network suffices as the communication distance. However, in addition to external noise, it is not possible to prevent interference of radio waves sent out from a nearby place, such as a house next door.

For example, in the case of a wireless LAN based on the IEEE 802.11 standards, CSMA/CA is adopted as a mechanism for preventing deterioration in transmission quality caused by radio interference. According to CSMA/CA, if a target appliance is receiving a radio wave transmitted from another appliance, the target appliance is prohibited from transmitting a radio wave until the transmission of the radio wave from the other appliance stops. If a state where the transmission of a radio wave is prohibited continues for a long time, transmission of audio data is interrupted. Also, if such a state occurs frequently, it is not possible to obtain enough throughput for streaming.

To avoid such a state, setting is preferably performed according to the environment. However, influence of radio interference is dependent on the wireless environment used by a user, the structure of a house, and the like. Thus, it is difficult for manufacturers manufacturing appliances to perform appropriate sensitivity adjustment at the time of shipping. For this reason, a technology of automatically adjusting the receiving sensitivity according to the environment is being studied.

For example, a model shown in FIG. 1 will be considered. FIG. 1 is an explanatory diagram showing models of interfering radio waves received by an access point 12 installed in a house 10. Adjoining houses 10 and 20 are shown in FIG. 1. Further, it is assumed that a wireless communication terminal 11 and the access point 12 are installed in the house 10. Similarly, a wireless communication terminal 21 and an access point 22 are installed in the house 20.

Let's assume that the wireless communication terminal 11 and the access point 12 are presently wirelessly communicating with each other in the house 10. It is also assumed that the wireless communication terminal 21 and the access point 22 are wirelessly communicating with each other in the house 20. In this case, a radio wave (a non-interfering radio wave) is being exchanged between the wireless communication terminal 11 and the access point 12. On the other hand, a part of a radio wave being exchanged between the wireless communication terminal 21 and the access point 22 reaches the access point 12 as an interfering radio wave. Also, it is conceivable that an interfering radio wave reaches the access point 12 from a place other than the house 20.

The strength of an interfering radio wave weakens by a physical distance or existence of an obstacle. Thus, a radio wave whose strength has been weakened is, even if it is a radio wave within the bandwidth of the wireless LAN, merely a noise of a quality not allowing identification. On the other hand, radio waves exchanged in the adjoining house 20 are not sufficiently weakened even at the stage where they have reached the house 10, and they possibly reach the access point 12 as signals of a quality allowing identification. Additionally, focus is placed here on the access point 12, but the wireless communication terminal 11 is also under the influence of the interfering radio wave. However, we will elaborate here on this matter focusing on the access point 12.

Among the radio waves reaching the access point 12, a non-interfering radio wave transmitted from the wireless communication terminal 11 is thought to be the strongest. Then, an interfering radio wave transmitted from the access point 22 or the wireless communication terminal 21 is thought to be the next strongest. However, which interfering radio wave is stronger depends on the environment. Here, it is assumed that the interfering radio wave transmitted from the access point 22 is stronger than the interfering radio wave transmitted from the wireless communication terminal 21. Additionally, it is assumed that an interfering radio wave transmitted from a place other than the house 20 is assumed to be weaker than the interfering radio wave transmitted from the access point 22 or the wireless communication terminal 21.

According to CSMA/CA, in the case the strength of an interfering radio wave exceeded the carrier sense level, the access point 12 is placed in a transmission wait state until the other appliance transmitting the interfering radio wave stops the transmission. For example, in the case the strength of an interfering radio wave transmitted from the access point exceeded the carrier sense level, transmission from the access point 12 is prohibited while the access point 22 is transmitting the radio wave. In a densely-populated area, for example, the strength of radio waves transmitted from appliances installed in adjoining houses frequently exceeds the carrier sense level. Thus, in such an environment, transmission of data is frequently interrupted.

As has been described, for the use of streaming audio data using a home wireless LAN, the communication distance of the wireless LAN may be limited to the distance between the appliances at home. Accordingly, with regard to the model shown in FIG. 1, it is preferable that radio waves transmitted from appliances outside the house 10 (for example, the wireless communication terminal 21 and the access point 22) are not sensed.

To stream audio data, sufficient transmission rate becomes necessary. If the transmission rate is not sufficient, the audio is interrupted. For example, under the condition of “sampling frequency=48 kHz, quantization bit rate=16 bits, stereo,” transmission rate sufficient for uninterrupted transmission of audio is about 1.5 Mbps. In the case of IEEE 802.11b/g, an effective transmission rate is thought to be about 50% of a physical transmission rate, and thus a high physical transmission rate of 3 Mbps or more is desired even when there is no obstacle. Therefore, in the case of streaming audio data, efforts have to be made to remove as much as possible factors that would reduce the effective transmission rate.

In the foregoing, influence of the radio interference has been described. Streaming of audio data has been taken as an example above, but the same can be said for streaming of video data.

### 1-2: Example Configuration of Audio Delivery System 100

Next, example configurations of an audio delivery system 100 capable of realizing streaming of audio data will be described with reference to FIGS. 2 to 6.

### 1-2-1: System Configuration

First, system configurations of the audio delivery system 100 will be described with reference to FIGS. 2 and 3. FIGS. 2 and 3 are explanatory diagrams showing example system configurations of the audio delivery system 100.

### Example 1

As shown in FIG. 2, the audio delivery system 100 may be configured from an access point 110 and an audio output device 120, for example. In the case of this configuration, audio data is input to the access point 110 by wire. When the audio data is input, the access point 110 wirelessly transmits the input audio data to the audio output device 120. When the audio data is received, the audio output device 120 outputs the received audio data. In this manner, a configuration where the access point 110 and the audio output device 120 are connected by a wireless LAN is conceivable.

### Example 2

Furthermore, as shown in FIG. 3, the audio delivery system 100 can also be configured from an access point 110, an audio output device 120, and an audio reproduction device 130, for example. In the case of this configuration, audio data is wirelessly transmitted from the audio reproduction device 130 to the access point 110. When the audio data is received, the access point 110 wirelessly transmits the received audio data to the audio output device 120. When the audio data is received, the audio output device 120 outputs the received audio data. In this manner, a configuration where the audio reproduction device 130 and the access point 110, and the access point 110 and the audio output device 120 are connected by a wireless LAN is conceivable.

In the foregoing, example system configurations of the audio delivery system 100 have been described. However, the example system configurations of the audio delivery system 100 are not limited to the above.

### 1-2-2: Example Configuration of Access Point 110

Next, an example configuration of the access point 110 will be described with reference to FIG. 4. FIG. 4 is an explanatory diagram showing an example configuration of the access point 110.

As shown in FIG. 4, the access point 110 is configured mainly from an antenna 111, an antenna switch 112, an RF processing unit 113, a wireless processing unit 114, a control unit 115 (MCU: a microcontroller unit), and a memory 116. Additionally, the example of FIG. 4 shows a configuration where one antenna 111 is used for transmission and reception by using a mechanism of switching between transmission and reception by the antenna switch 112, but it is also possible to separately provide a transmitting antenna and a receiving antenna.

### (Operation at the Time of Reception)

First, an operation at the time of reception will be described.

A signal received by the antenna 111 is input to the RF processing unit 113 via the antenna switch 112. When the signal is input, the RF processing unit 113 performs processing that is to be performed before digitalization of the signal, such as signal amplification, detection, demodulation, or the like. The signal output from the RF processing unit 113 is input to the wireless processing unit 114. The wireless processing unit 114 converts the input signal into a digital signal. Then, the wireless processing unit 114 extracts an ESS-ID of the transmission source from the digital signal. Then, the wireless processing unit 114 checks the extracted ESS-ID against the ESS-ID that its belonging access point 110 holds, and determines whether the input signal is a signal transmitted from a network connection destination.

Also, the wireless processing unit 114 interprets a control command contained in the digital signal, and controls transmission/reception of signal according to the control command. Furthermore, the wireless processing unit 114 extracts data from a packet, or controls processing related to transmission/reception of data, for example. Also, the wireless processing unit 114 has a function of setting the receiving sensitivity, as will be described later. Additionally, data from which a redundant portion such as a header has been removed by the wireless processing unit 114 is stored in the memory 116. Furthermore, operations of the antenna switch 112, the RF processing unit 113, and the wireless processing unit 114 are controlled by the control unit 115.

### (Operation at the Time of Transmission)

Next, an operation at the time of transmission will be described.

First, the wireless processing unit 114 reads data stored in the memory 116. Then, the wireless processing unit 114 converts the data according to a wireless protocol, adds auxiliary information or the like, and generates a digital signal. Then, the wireless processing unit 114 converts the digital signal into an analogue signal. The analogue signal output from the wireless processing unit 114 is input to the RF processing unit 113. When the analogue signal is input, the RF processing unit 113 performs carrier modulation on the input analogue signal. Furthermore, the RF processing unit 113 amplifies the power of the analogue signal on which carrier modulation has been performed, and transmits the same from the antenna 111 via the antenna switch 112.

In the foregoing, an example configuration of the access point 110 has been described.

### 1-2-3: Example Configuration of Audio Output Device 120

Next, an example configuration of the audio output device 120 will be described with reference to FIG. 5. FIG. 5 is an explanatory diagram showing an example configuration of the audio output device 120.

As shown in FIG. 5, the audio output device 120 is mainly configured from an antenna 121, an antenna switch 122, an RF processing unit 123, a wireless processing unit 124, an audio processing unit 125, a control unit 126 (MCU), an audio output unit 127, and a memory 128. Additionally, the example of FIG. 5 shows a configuration where one antenna 121 is used for transmission and reception by using a mechanism of switching between transmission and reception by the antenna switch 122, but it is also possible to separately provide a transmitting antenna and a receiving antenna.

### (Operation at the Time of Reception)

First, an operation at the time of reception will be described.

A signal received by the antenna 121 is input to the RF processing unit 123 via the antenna switch 122. When the signal is input, the RF processing unit 123 performs processing that is to be performed before digitalization of the signal, such as signal amplification, detection, demodulation, or the like. The signal output from the RF processing unit 123 is input to the wireless processing unit 124. The wireless processing unit 124 converts the input signal into a digital signal. Then, the wireless processing unit 124 extracts an ESS-ID of the transmission source from the digital signal. Then, the wireless processing unit 124 checks the extracted ESS-ID against the ESS-ID that its belonging audio output device 120 holds, and determines whether the input signal is a signal transmitted from a network connection destination.

Also, the wireless processing unit 124 interprets a control command contained in the digital signal, and controls transmission/reception of signal according to the control command. Furthermore, the wireless processing unit 124 extracts data from a packet, or controls processing related to transmission/reception of data, for example. Also, the wireless processing unit 124 has a function of setting the receiving sensitivity, as will be described later. Additionally, data from which a redundant portion such as a header has been removed by the wireless processing unit 124 is input to the audio processing unit 125. For example, information data such as metadata, audio data, data that is output in response to a request from the control unit 126, or the like is input to the audio processing unit 125.

The audio data that is output from the wireless processing unit 124 is not in synchronization with a sampling frequency defined by a digital audio format. Accordingly, the audio processing unit 125 stores the input audio data in the memory 128. Then, the audio processing unit 125 reads the audio data from the memory 128 in synchronization with the sampling frequency defined by the digital audio format, and inputs the same to the audio output unit 127. The audio output unit 127 outputs the input audio data. Additionally, operations of the antenna switch 122, the RF processing unit 123, the wireless processing unit 124, and the audio processing unit 125 are controlled by the control unit 126.

### (Operation at the Time of Transmission)

Next, an operation at the time of transmission will be described.

First, the wireless processing unit 124 converts the transmission data output from the control unit 126 according to a wireless protocol, adds auxiliary information or the like, and generates a digital signal. Then, the wireless processing unit 124 converts the digital signal into an analogue signal. The analogue signal output from the wireless processing unit 124 is input to the RF processing unit 123. When the analogue signal is input, the RF processing unit 123 performs carrier modulation on the input analogue signal. Furthermore, the RF processing unit 123 amplifies the power of the analogue signal on which carrier modulation has been performed, and transmits the same from the antenna 121 via the antenna switch 122.

In the foregoing, an example configuration of the audio output device 120 has been described.

### 1-2-4: Example Configuration of Audio Reproduction Device 130

Next, an example configuration of the audio reproduction device 130 will be described with reference to FIG. 6. FIG. 6 is an explanatory diagram showing an example configuration of the audio reproduction device 130.

As shown in FIG. 6, the audio reproduction device 130 is mainly configured from an antenna 131, an antenna switch 132, an RF processing unit 133, a wireless processing unit 134, an audio processing unit 135, a control unit 136 (MCU), an audio reproduction unit 137, and a memory 138. Additionally, the example of FIG. 6 shows a configuration where one antenna 131 is used for transmission and reception by using a mechanism of switching between transmission and reception by the antenna switch 132, but it is also possible to separately provide a transmitting antenna and a receiving antenna.

### (Operation at the Time of Reception)

First, an operation at the time of reception will be described.

A signal received by the antenna 131 is input to the RF processing unit 133 via the antenna switch 132. When the signal is input, the RF processing unit 133 performs processing that is to be performed before digitalization of the signal, such as signal amplification, detection, demodulation, or the like. The signal output from the RF processing unit 133 is input to the wireless processing unit 134. The wireless processing unit 134 converts the input signal into a digital signal. Then, the wireless processing unit 134 extracts an ESS-ID of the transmission source from the digital signal. Then, the wireless processing unit 134 checks the extracted ESS-ID against the ESS-ID that its belonging audio reproduction device 130 holds, and determines whether the input signal is a signal transmitted from a network connection destination.

Also, the wireless processing unit 134 interprets a control command contained in the digital signal, and controls transmission/reception of signal according to the control command. Furthermore, the wireless processing unit 134 extracts data from a packet, or controls processing related to transmission/reception of data, for example. Also, the wireless processing unit 134 has a function of setting the receiving sensitivity, as will be described later. Additionally, data from which a redundant portion such as a header has been removed by the wireless processing unit 134 is input to the control unit 136. Additionally, operations of the antenna switch 132, the RF processing unit 133, the wireless processing unit 134, and the audio processing unit 135 are controlled by the control unit 136.

### (Operation at the Time of Transmission)

Next, an operation at the time of transmission will be described.

First, the audio reproduction unit 137 acquires audio data from a recording medium, a television receiver or the like, and inputs the same to the audio processing unit 135 in synchronization with a sampling frequency defined by a digital audio format. When the audio data is input, the audio processing unit 135 stores the input audio data in the memory 138. Then, the audio processing unit 135 reads the audio data from the memory 138 in response to a request from the wireless processing unit 134, and inputs the audio data that has been read to the wireless processing unit 134.

Next, the wireless processing unit 134 converts the audio data according to a wireless protocol, adds auxiliary information or the like, and generates a digital signal. Then, the wireless processing unit 134 converts the digital signal into an analogue signal. The analogue signal output from the wireless processing unit 134 is input to the RF processing unit 133. When the analogue signal is input, the RF processing unit 133 performs carrier modulation on the input analogue signal. Furthermore, the RF processing unit 133 amplifies the power of the analogue signal on which carrier modulation has been performed, and transmits the same from the antenna 131 via the antenna switch 132.

In the foregoing, an example configuration of the audio reproduction device 130 has been described. Additionally, the audio reproduction device 130 may further include an audio output unit that is not shown.

### 1-3: Streaming

As described above, rules to be physical standards for wireless operation that is performed at the block from the antenna (121, 131) to the wireless processing unit (124, 134) are different from standards related to input/output of audio data. That is, the timing of transmission/reception, the packet size, the transmission rate, and the like are not in synchronization with a sampling frequency defined by a digital audio format. Thus, the audio processing unit (125, 135) stores audio data in the memory (128, 138), and adjusts the output timing of the audio data. Accordingly, to continuously deliver audio data using the wireless LAN, a relationship of effective transmission rate of wireless LAN>>sampling rate of audio data has to be satisfied. Therefore, a measure for preventing reduction in an effective throughput caused by timing control according to CSMA/CA or the like is desired.

In view of the circumstances, the present inventor has devised a mechanism of recognising a radio wave transmitted from an appliance that is not on one's network and adjusting the sensitivity so that the radio wave is not received. By using this mechanism, it becomes possible to smoothly stream audio data using a home wireless LAN. Additionally, an explanation is given here taking a wireless LAN as an example, but a similar mechanism can also be constructed by using Bluetooth (registered trademark) or another wireless communication means. Also, an explanation is given taking streaming of audio data as an example, but the same mechanism can be applied in a case of streaming other types of data such as video data. This mechanism will be described below in greater detail.

### 2. Embodiment

An embodiment of the present technology will be described. The present embodiment relates to a function of the wireless processing unit (114, 124, 134) described above.

### 2-1: Example Configuration of Wireless Processing Units 114, 124, 134

First, an example configuration of the wireless processing unit (114, 124, 134) according to the present embodiment will be described with reference to FIG. 7. FIG. 7 is an explanatory diagram showing an example configuration of the wireless processing unit (114, 124, 134) according to the present embodiment. Additionally, the example configuration shown in FIG. 7 shows only the elements (a reception block) according to the present embodiment, among the elements configuring the wireless processing unit (114, 124, 134).

As shown in FIG. 7, the reception block of the wireless processing unit (114, 124, 134) includes an AD converter 141, a filter 142, a demodulation unit 143, a MAC processing unit 144, an RSSI detection unit 145, and a delay processing unit 146. Additionally, RSSI is an abbreviation for Received Signal Strength Indication. Also, MAC is an abbreviation for Media Access Control.

A signal which has been converted to an intermediate frequency (IF) (hereinafter, an IF signal) by the RF processing unit (113, 123, 133) is input to the AD converter 141. The AD converter 141 converts the input analogue IF signal into a digital signal, and inputs the same to the filter 142 and the RSSI detection unit 145. If the strength of the input digital signal exceeds a threshold, the filter 142 inputs the digital signal to the demodulation unit 143. That is, the threshold of the filter 142 decides the receiving sensitivity. The demodulation unit 143 demodulates the digital signal that has passed through the filter 142, and inputs the signal for which contents of a packet have been converted into a readable format to the MAC processing unit 144.

The MAC processing unit 144 determines the appliance which has transmitted the packet, the network to which the appliance belongs, and an appliance to which the packet is transmitted. The MAC processing unit 144 interprets the contents of a packet if it is a packet transmitted from an appliance on its belonging network, performs predetermined processing, and outputs it to the following block. On the other hand, if it is a packet transmitted from an appliance on a network that it does not belong to, the MAC processing unit 144 performs adjustment of the receiving sensitivity described later.

The RSSI detection unit 145 detects the strength of the input digital signal (RSSI). The RSSI detected by the RSSI detection unit 145 is input to the delay processing unit 146. The delay processing unit 146 delays the output of the RSSI for a period of time until the digital signal that has passed through the filter 142 is demodulated by the demodulation unit 143. After the delay, the RSSI is input to the MAC processing unit 144. Additionally, in the case of performing adjustment of the receiving sensitivity, the MAC processing unit 144 sets the input RSSI as the threshold of the filter 142. By the setting of the threshold, a digital signal transmitted from an appliance on a network to which it does not belong can be removed by the filter 142.

In the foregoing, an example configuration of the reception block of the wireless processing unit (114, 124, 134) has been described.

### 2-2: Sensitivity Adjustment Method (Case of Access Point 110)

Next, a sensitivity adjustment method according to the present embodiment will be described.

### 2-2-1: Basic Configuration

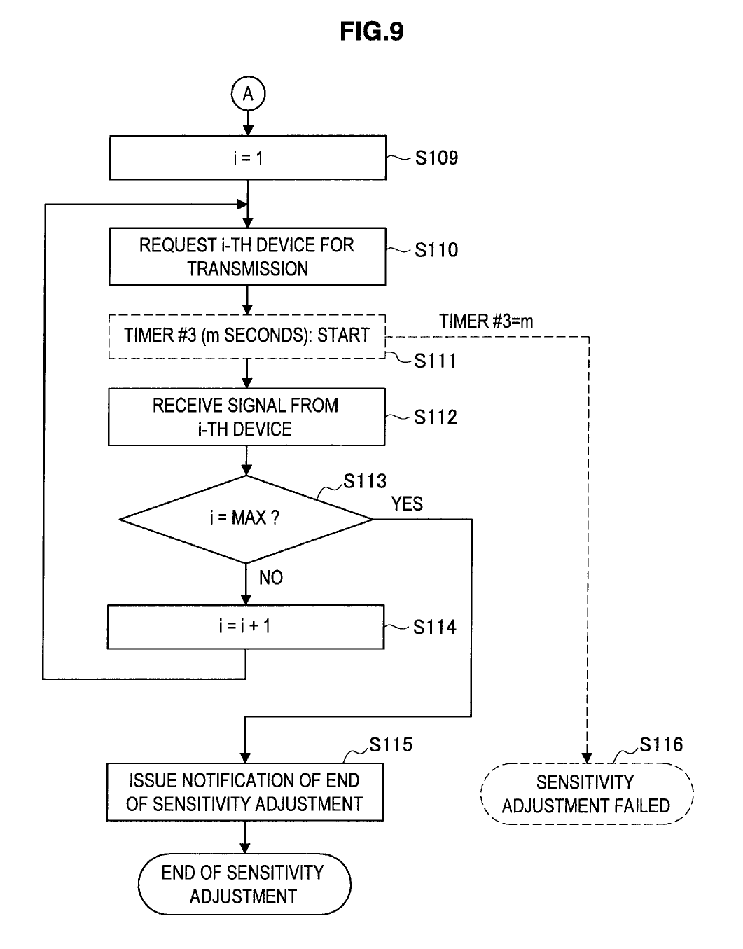

Now, a basic configuration of the sensitivity adjustment method according to the present embodiment will be described with reference to FIGS. 8 and 9. FIGS. 8 and 9 are explanatory diagrams for describing the basic configuration of the sensitivity adjustment method according to the present embodiment. Additionally, the sensitivity adjustment method described below is related to the access point 110. Also, the sensitivity adjustment method described below is realized mainly by the function of the wireless processing unit 114.

As shown in FIG. 8, when sensitivity adjustment is started, the wireless processing unit 114 starts a timer #1 (S101). This timer #1 is assumed to be a timer for counting up to N seconds. Furthermore, when the timer #1 has reached N seconds, the wireless processing unit 114 proceeds with the process to step A even if processing steps of steps S102 to S108 are being performed. Then, the wireless processing unit 114 notifies all the devices connected to the same network, by broadcasting, of start of the sensitivity adjustment (S102). For example, the wireless processing unit 114 notifies the audio output device 120 and the audio reproduction device 130 of the start of the sensitivity adjustment.

Then, the wireless processing unit 114 determines whether an ACK is received from each of all the devices which have been notified of the start of the sensitivity adjustment in step S102 (S103). If the ACK is received from all of the devices, the wireless processing unit 114 proceeds with the process to step S104. On the other hand, if the ACK is not received from at least one device, the wireless processing unit 114 returns the process to step S103, and repeats the process of step S103.

In the case the process proceeds to step S104, the wireless processing unit 114 falls into a reception wait state, and determines whether a signal is received or not (S104). If a signal is received, the wireless processing unit 114 proceeds with the process to step S105. On the other hand, if a signal is not received, the wireless processing unit 114 returns the process to step S104, and repeats the process of step S104.

In the case the process proceeds to step S105, the wireless processing unit 114 determines whether the received signal is a non-interfering signal or not (S105). That is, the wireless processing unit 114 determines whether the received signal is a signal which has been transmitted from a device connected to the same network (a non-interfering signal). If the received signal is a non-interfering signal, the wireless processing unit 114 proceeds with the process to step S104. On the other hand, if the received signal is not a non-interfering signal, the wireless processing unit 114 proceeds with the process to step S106.

In the case the process proceeds to step S106, the wireless processing unit 114 reads the RSSI of the received signal (S106). Then, the wireless processing unit 114 sets a filter threshold X to be equal to or greater than the RSSI (S107). Then, the wireless processing unit 114 starts a timer #2 (S108), and proceeds with the process to step S104. This timer #2 is assumed to be a timer for counting up to n seconds. Furthermore, when the timer #2 has reached n seconds, the wireless processing unit 114 proceeds with the process to step A even if processing steps of steps S104 to S108 are being performed.

As shown in FIG. 9, in the case the process proceeds to step A, the wireless processing unit 114 resets an index i to 1 (S109). Then, the wireless processing unit 114 requests an i-th device, among devices connected to the same network, for transmission of a data signal (S110). Then, the wireless processing unit 114 starts a timer #3 (S111). This timer #3 is assumed to be a timer for counting up to m seconds. Furthermore, when the timer #3 has reached m seconds, the wireless processing unit 114 proceeds with the process to step S116 even if processing steps of steps S112 to S114 are being performed.

Next, the wireless processing unit 114 receives a data signal from the i-th device (S112), and proceeds with the process to step S113. If a data signal from the i-th device is not received, the wireless processing unit 114 waits until a data signal is received from the i-th device. In the case the process proceeds to step S113, the wireless processing unit 114 determines whether i is equal to MAX (S113). Additionally, MAX is the total number of devices connected to the same network. If i is equal to MAX, the wireless processing unit 114 proceeds with the process to step S115. On the other hand, if i is not equal to MAX, the wireless processing unit 114 proceeds with the process to step S114.

In the case the process proceeds to step S114, the wireless processing unit 114 increases the index i by 1 (S114), and proceeds with the process to step S110. On the other hand, in the case the process proceeds to step S115, the wireless processing unit 114 notifies all the devices connected to the same network of the end of the sensitivity adjustment (S115), and ends the series of processes related to the sensitivity adjustment.

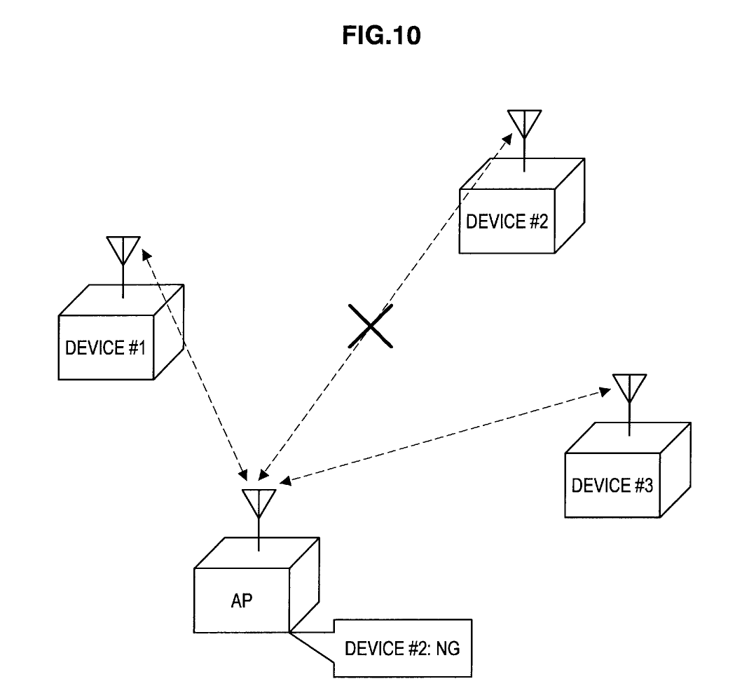

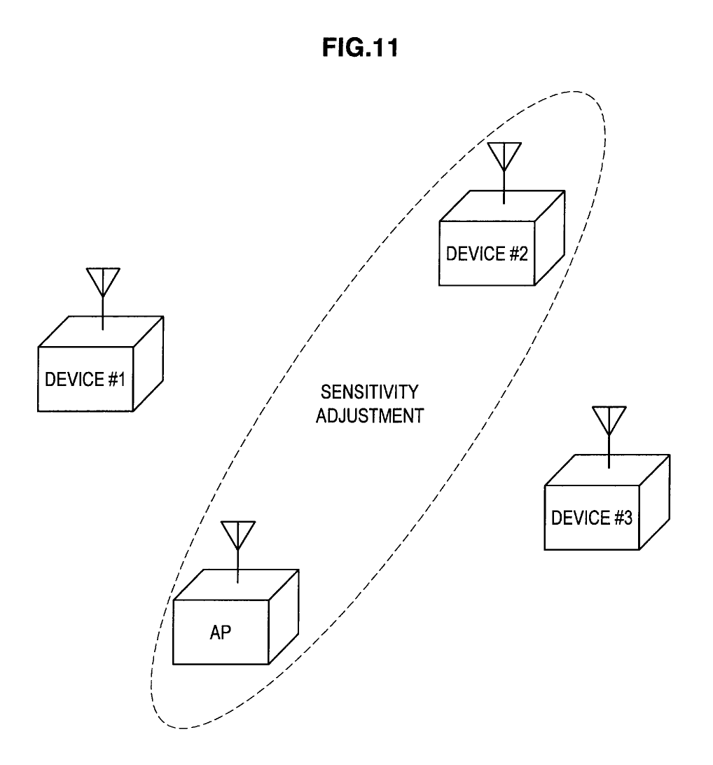

Furthermore, in the case the timer #3 reaches timeout in the middle of processing and the process proceeds to step S116, the wireless processing unit 114 performs error processing, assuming that the sensitivity adjustment has failed (S116). For example, as shown in FIG. 10, the wireless processing unit 114 displays on a display device (not shown) information of the device from which a data signal was not received. At this time, a user may be prompted to change the installation position of the device. Furthermore, as shown in FIG. 11, the wireless processing unit 114 again performs the sensitivity adjustment for the device from which a data signal was not received.

In the foregoing, a basic configuration of the sensitivity adjustment method according to the present embodiment has been described.

### 2-2-2: Modified Example #1 (Channel Change)

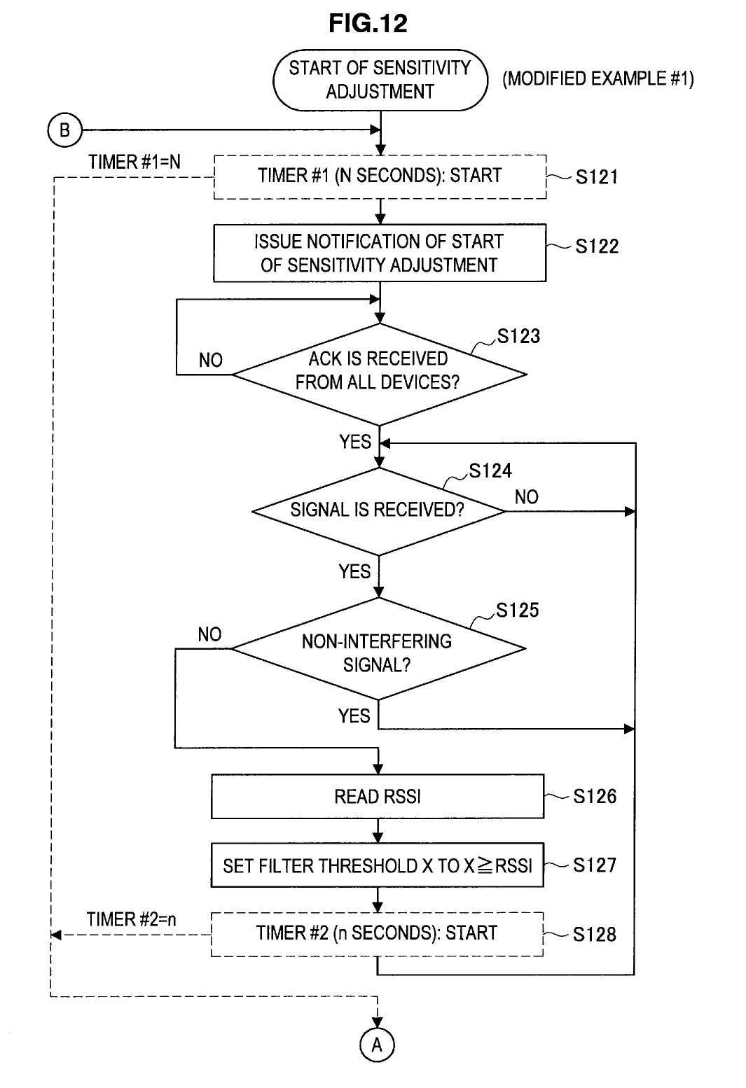

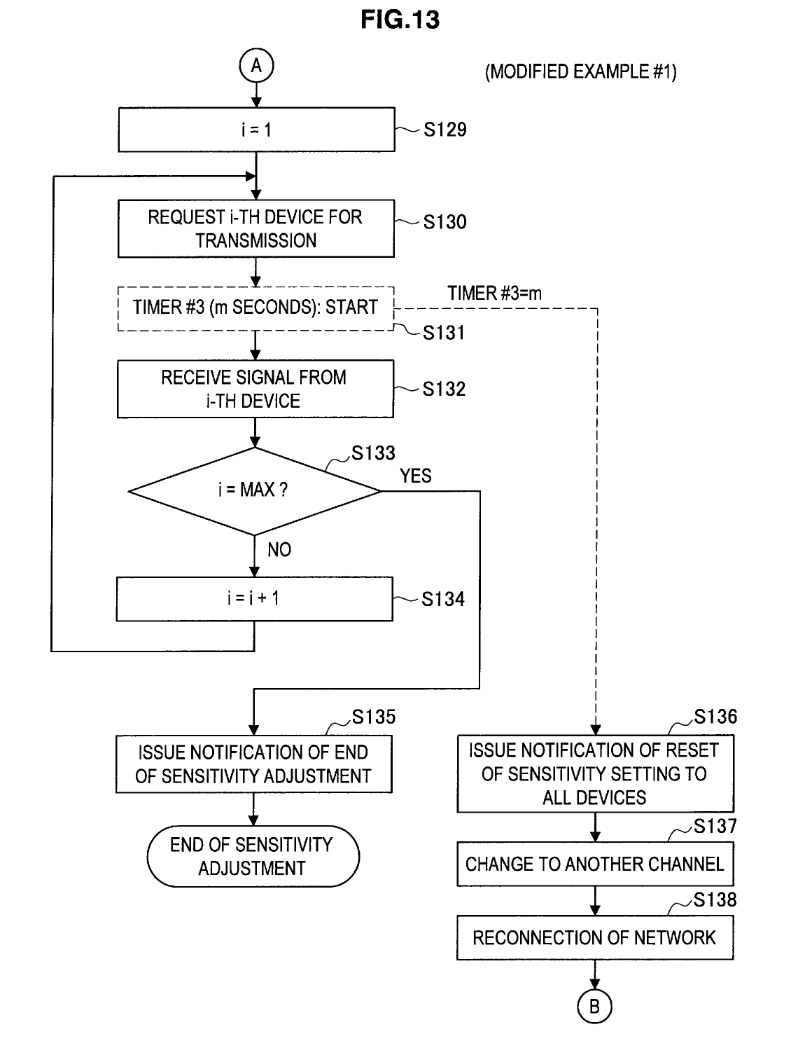

Next, a configuration of a sensitivity adjustment method according to a modified example (modified example #1) of the present embodiment will be described with reference to FIGS. 12 and 13. FIGS. 12 and 13 are explanatory diagrams for describing a configuration of the sensitivity adjustment method according to a modified example (modified example #1) of the present embodiment. Additionally, the sensitivity adjustment method described below is for the access point 110. Also, the sensitivity adjustment method described below is realized mainly by the function of the wireless processing unit 114.

As shown in FIG. 12, when sensitivity adjustment is started, the wireless processing unit 114 starts a timer #1 (S121). This timer #1 is assumed to be a timer for counting up to N seconds. Furthermore, when the timer #1 has reached N seconds, the wireless processing unit 114 proceeds with the process to step A even if processing steps of steps S122 to S128 are being performed. Then, the wireless processing unit 114 notifies all the devices connected to the same network, by broadcasting, of start of the sensitivity adjustment (S122). For example, the wireless processing unit 114 notifies the audio output device 120 and the audio reproduction device 130 of the start of the sensitivity adjustment.

Then, the wireless processing unit 114 determines whether an ACK is received from each of all the devices which have been notified of the start of the sensitivity adjustment in step S122 (S123). If the ACK is received from all of the devices, the wireless processing unit 114 proceeds with the process to step S124. On the other hand, if the ACK is not received from at least one device, the wireless processing unit 114 returns the process to step S123, and repeats the process of step S123.

In the case the process proceeds to step S124, the wireless processing unit 114 falls into a reception wait state, and determines whether a signal is received or not (S124). If a signal is received, the wireless processing unit 114 proceeds with the process to step S125. On the other hand, if a signal is not received, the wireless processing unit 114 returns the process to step S124, and repeats the process of step S124.

In the case the process proceeds to step S125, the wireless processing unit 114 determines whether the received signal is a non-interfering signal or not (S125). That is, the wireless processing unit 114 determines whether the received signal is a signal which has been transmitted from an appliance connected to the same network (a non-interfering signal). If the received signal is a non-interfering signal, the wireless processing unit 114 proceeds with the process to step S124. On the other hand, if the received signal is not a non-interfering signal, the wireless processing unit 114 proceeds with the process to step S126.

In the case the process proceeds to step S126, the wireless processing unit 114 reads the RSSI of the received signal (S126). Then, the wireless processing unit 114 sets a filter threshold X to be equal to or greater than the RSSI (S127). Then, the wireless processing unit 114 starts a timer #2 (S128), and proceeds with the process to step S124. This timer #2 is assumed to be a timer for counting up to n seconds. Furthermore, when the timer #2 has reached n seconds, the wireless processing unit 114 proceeds with the process to step A even if processing steps of steps S124 to S128 are being performed.

As shown in FIG. 13, in the case the process proceeds to step A, the wireless processing unit 114 resets an index i to 1 (S129). Then, the wireless processing unit 114 requests an i-th device, among devices connected to the same network, for transmission of a data signal (S130). Then, the wireless processing unit 114 starts a timer #3 (S131). This timer #3 is assumed to be a timer for counting up to m seconds. Furthermore, when the timer #3 has reached m seconds, the wireless processing unit 114 proceeds with the process to step S136 even if processing steps of steps S132 to S134 are being performed.

Next, the wireless processing unit 114 receives a data signal from the i-th device (S132), and proceeds with the process to step S133. If a data signal from the i-th device is not received, the wireless processing unit 114 waits until a data signal is received from the i-th device. In the case the process proceeds to step S133, the wireless processing unit 114 determines whether i is equal to MAX (S133). Additionally, MAX is the total number of devices connected to the same network. If i is equal to MAX, the wireless processing unit 114 proceeds with the process to step S135. On the other hand, if i is not equal to MAX, the wireless processing unit 114 proceeds with the process to step S134.

In the case the process proceeds to step S134, the wireless processing unit 114 increases the index i by 1 (S134), and proceeds with the process to step S130. On the other hand, in the case the process proceeds to step S135, the wireless processing unit 114 notifies all the devices connected to the same network of the end of the sensitivity adjustment (S135), and ends the series of processes related to the sensitivity adjustment.

Furthermore, in the case the timer #3 reaches timeout in the middle of processing and the process proceeds to step S136, the wireless processing unit 114 notifies all the devices connected to the same network to reset the sensitivity setting (S136). Then, the wireless processing unit 114 changes the wireless communication channel to another channel (S137). Then, the wireless processing unit 114 performs reconnection of the network (S138), and proceeds with the process to step B. That is, after performing the process of step S138, the wireless processing unit 114 performs again the process of sensitivity adjustment starting from step S121 in FIG. 12.

In the foregoing, a configuration of the sensitivity adjustment method according to a modified example (modified example #1) of the present embodiment has been described above.

### 2-2-3: Modified Example #2 (Step-by-Step Reduction in Sensitivity)

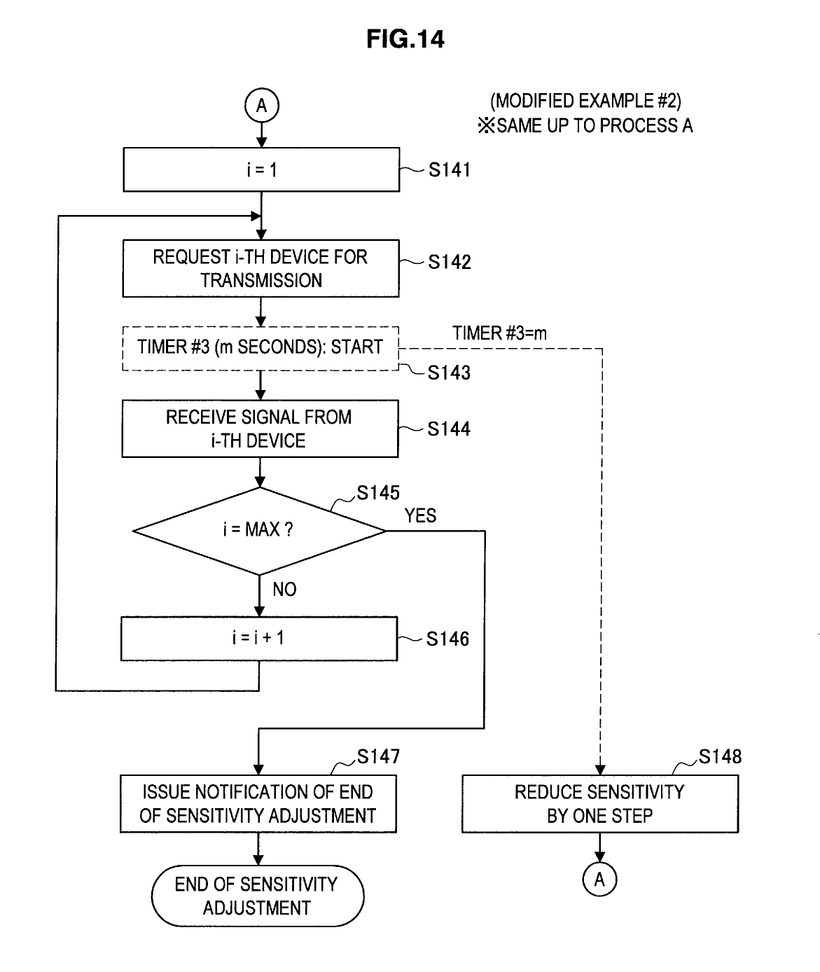

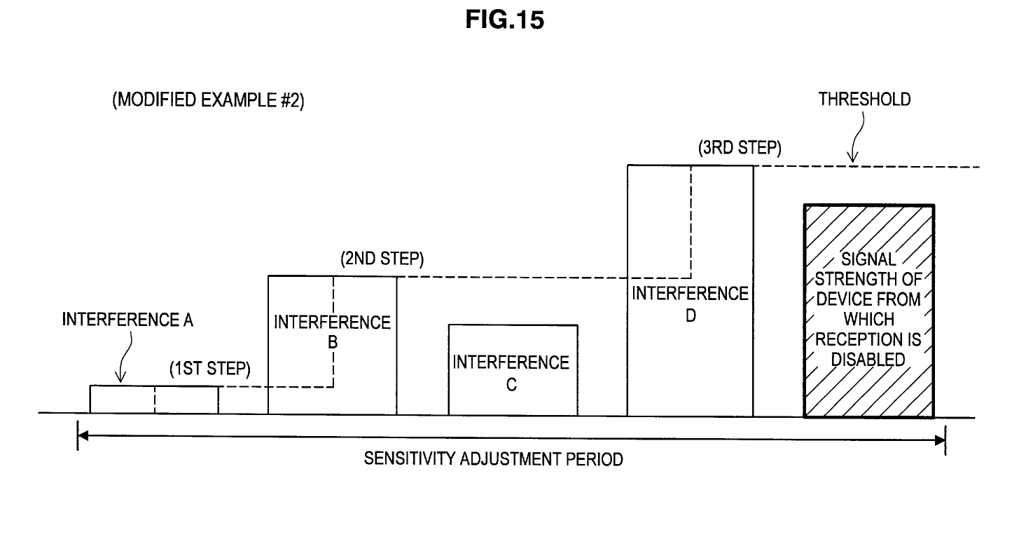

Next, a configuration of a sensitivity adjustment method according to a modified example (modified example #2) of the present embodiment will be described with reference to FIGS. 14 and 15. FIGS. 14 and 15 are explanatory diagrams for describing a configuration of the sensitivity adjustment method according to a modified example (modified example #2) of the present embodiment. Additionally, the sensitivity adjustment method described below is for the access point 110. Also, the sensitivity adjustment method described below is realized mainly by the function of the wireless processing unit 114. Moreover, the processing from the start of the sensitivity adjustment to step A is the same as that in FIG. 8, and thus an explanation related to the processing up to step A is omitted.

As shown in FIG. 14, in the case the process proceeds to step A, the wireless processing unit 114 resets an index i to 1 (S141). Then, the wireless processing unit 114 requests an i-th device, among devices connected to the same network, for transmission of a data signal (S142). Then, the wireless processing unit 114 starts a timer #3 (S143). This timer #3 is assumed to be a timer for counting up to m seconds. Furthermore, when the timer #3 has reached m seconds, the wireless processing unit 114 proceeds with the process to step S148 even if processing steps of steps S144 to S146 are being performed.

Next, the wireless processing unit 114 receives a data signal from the i-th device (S144), and proceeds with the process to step S145. If a data signal from the i-th device is not received, the wireless processing unit 114 waits until a data signal is received from the i-th device. In the case the process proceeds to step S145, the wireless processing unit 114 determines whether i is equal to MAX (S145). Additionally, MAX is the total number of devices connected to the same network. If i is equal to MAX, the wireless processing unit 114 proceeds with the process to step S147. On the other hand, if i is not equal to MAX, the wireless processing unit 114 proceeds with the process to step S146.

In the case the process proceeds to step S146, the wireless processing unit 114 increases the index i by 1 (S146), and proceeds with the process to step S142. On the other hand, in the case the process proceeds to step S147, the wireless processing unit 114 notifies all the devices connected to the same network of the end of the sensitivity adjustment (S147), and ends the series of processes related to the sensitivity adjustment.

Furthermore, in the case the timer #3 reaches timeout in the middle of processing and the process proceeds to step S148, the wireless processing unit 114 reduces the receiving sensitivity by one step (S148), and proceeds with the process to step A. That is, the wireless processing unit 114 raises a filter threshold X by one step, as shown in FIG. 15. The amount of the raise may be a predetermined value or, as shown in FIG. 15, may be determined based on the RSSI of interfering signals while tolerating one interfering signal at a time. If there is a device from which a data signal is not received even after the sensitivity is reduced, the sensitivity is further reduced by one step. These processes are repeatedly performed until data signals from all the devices connected to the same network can be received.

In the foregoing, a configuration of the sensitivity adjustment method according to a modified example (modified example #2) of the present embodiment has been described.

### 2-3: Sensitivity Adjustment Method (Case of Terminal)

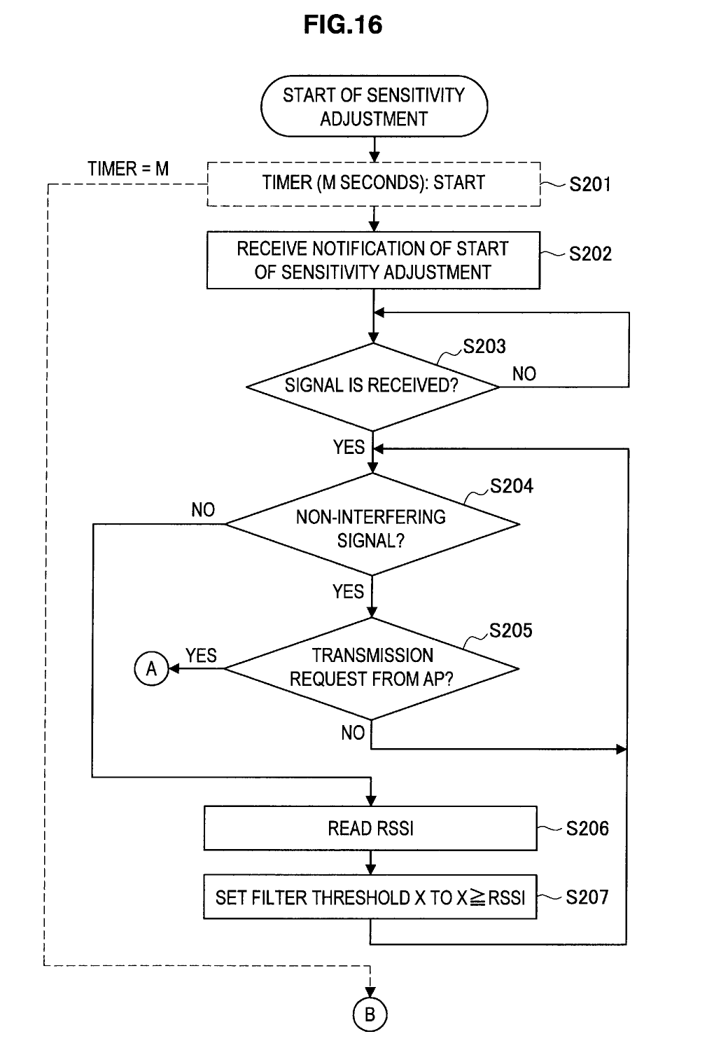

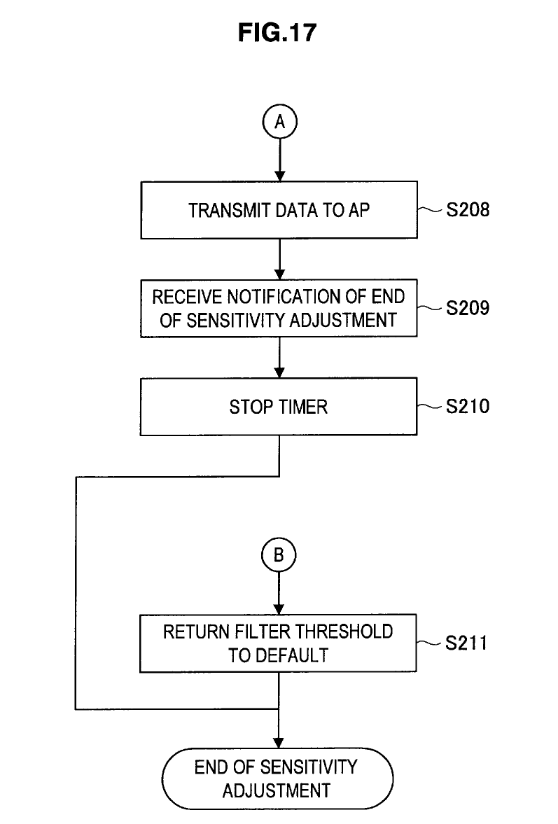

Next, a configuration of the sensitivity adjustment method according to the present embodiment will be described with reference to FIGS. 16 and 17. FIGS. 16 and 17 are explanatory diagrams for describing a configuration of the sensitivity adjustment method according to the present embodiment. Additionally, the sensitivity adjustment method described below is for the audio output device 120 and the audio reproduction device 130 (terminal). Also, the sensitivity adjustment method described is realized mainly by the function of the wireless processing unit (124, 134).

As shown in FIG. 16, when sensitivity adjustment is started, the wireless processing unit (124, 134) starts a timer (S201). This time is assumed to be a timer for counting up to M seconds. Furthermore, when the timer has reached M seconds, the wireless processing unit (124, 134) proceeds with the process to step B even if processing steps of steps S202 to S209 are being performed. Then, the wireless processing unit (124, 134) receives from the access point 110 a notification of start of sensitivity adjustment (S202). Also, the wireless processing unit (124, 134) returns to the access point 110 an ACK indicating reception of the notification of start of sensitivity adjustment.

Next, the wireless processing unit (124, 134) falls into a reception wait state, and determines whether a signal is received or not (S203). If a signal is received, the wireless processing unit (124, 134) proceeds with the process to step S204. On the other hand, if a signal is not received, the wireless processing unit (124, 134) returns the process to step S203, and repeats the process of step S203. In the case the process proceeds to step S204, the wireless processing unit (124, 134) determines whether the received signal is a non-interfering signal or not (S204). That is, the wireless processing unit (124, 134) determines whether the received signal is a signal which has been transmitted from a device connected to the same network (a non-interfering signal).

If the received signal is a non-interfering signal, the wireless processing unit (124, 134) proceeds with the process to step S205. On the other hand, if the received signal is not a non-interfering signal, the wireless processing unit (124, 134) proceeds with the process to step S206. In the case the process proceeds to step S205, the wireless processing unit (124, 134) determines whether the received non-interfering signal is a transmission request for a data signal which has been transmitted from the access point 110 (S205). If it is a transmission request for a data signal, the wireless processing unit (124, 134) proceeds with the process to step A. On the other hand, if it is not a transmission request for a data signal, the wireless processing unit (124, 134) proceeds with the process to step S204.

In the case the process proceeds to step S206, the wireless processing unit (124, 134) reads the RSSI of the received signal (S206). Then, the wireless processing unit (124, 134) sets a filter threshold X to be equal to or greater than the RSSI (S207), and proceeds with the process to step S204.

As shown in FIG. 17, in the case the process proceeds to step A, the wireless processing unit (124, 134) transmits a data signal to the access point 110 (S208). Then, the wireless processing unit (124, 134) receives a notification of end of sensitivity adjustment from the access point 110 (S209), and proceeds with the process to step S210. Additionally, if a notification of end of sensitivity adjustment is not received, the wireless processing unit (124, 134) remains waiting. In the case the process proceeds to step S210, the wireless processing unit (124, 134) stops the timer (S210), and ends the series of processes related to the sensitivity adjustment.

Furthermore, in the case the timer reaches timeout in the middle of processing and the process proceeds to step B, the wireless processing unit (124, 134) returns the filter threshold X to a predetermined value (S211), and ends the series of processes related to the sensitivity adjustment.

In the foregoing, a configuration of the sensitivity adjustment method according to the present embodiment has been described.

### 2-4: Configuration for Secure Reception of ACK

As has been described above, various signals are exchanged to perform sensitivity adjustment, such as a notification of start of sensitivity adjustment, a notification of end of sensitivity adjustment, a transmission request for a data signal, transmission of a data signal in response to the transmission request, and the like. A device on the receiving end returns an ACK to a device on the transmitting end in a case a signal is properly received.

According to CSMA/CA, an ACK is to be returned immediately after the duration of a SIFS (Short Inter Frame Space) after transmission of a signal (transmission data). Accordingly, the timing of returning of the ACK can be predicted.

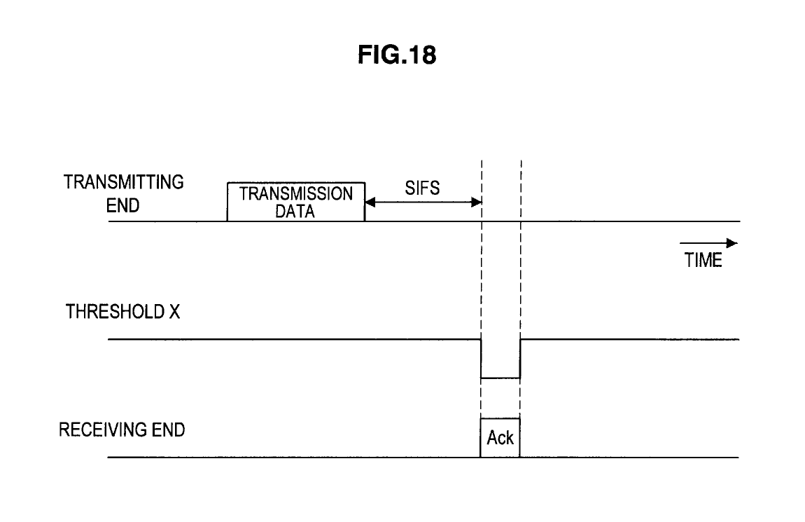

Thus, the wireless processing unit (114, 124, 134) predicts the timing of returning of the ACK, and lowers the filter threshold X only during the period of reception of the ACK as shown in FIG. 18. By adjusting the filter threshold X in this manner, the ACK can be surely received. If the ACK can be surely received, the chances of packet retransmission control being performed can be reduced, and substantial data transmission efficiency can be improved.

### 3. Summary

Lastly, the technical ideas according to the present embodiment will be briefly described. The technical ideas stated here can be applied to various appliances, such as a personal computer, a mobile phone, a game console, a portable information terminal, an information appliance, a car navigation system, a television receiver, a video playback device, a video recording/playback device, a music playback device, a music output device, and the like.

The functional configuration of the appliance described above can be expressed as below. The appliance includes a filter, a signal distinguishing unit, and a threshold adjustment unit described below. The filter is for removing a signal whose strength is below a threshold. The signal distinguishing unit is for distinguishing between a non-interfering signal that is transmitted/received in a network that the appliance is connected to and an interfering signal that is transmitted/received in a network that the appliance is not connected to. The threshold adjustment unit is for raising, in a case an interfering signal passed through the filter, the threshold to a level that causes the interfering signal to be removed by the filter.

The appliance described above regards a signal that is transmitted/received by an appliance in the same network as the non-interfering signal, and regards a signal that is transmitted/received by an appliance in a different network as the interfering signal. Then, in a case an interfering signal is received, the appliance described above removes the interfering signal by the filter. Also, in the case an interfering signal passed through the filter, the appliance described above raises the threshold to a level that causes the interfering signal to not pass through the filter. That is, the appliance described above adjusts the receiving sensitivity according to reception of an interfering signal.

According to this configuration, not only external noise, but also a signal that is transmitted/received in a nearby network (an interfering signal) can be removed. As a result, implementation of timing control that would stop transmission of signals until transmission of interfering signals stops can be suppressed, and the chances of continuous transmission/reception of a signal being interrupted by the timing control according to reception of an interfering signal can be reduced. For example, in the case of transmitting data such as a video or audio that is being streamed, poor functioning such as transmission of the data being interrupted in the middle by the timing control as described above can be avoided.

### (Notes)

The MAC processing unit 144 described above is an example of a signal distinguishing unit and a threshold adjustment unit. The wireless processing unit (114, 124, 134) described above is an example of a signal transmission unit, a signal reception unit, a reception period prediction unit, a signal request unit, and a channel change unit. The access point 110, the audio output device 120, and the audio reproduction device 130 described above are examples of a wireless communication apparatus. Furthermore, the audio delivery system 100 described above is an example of a wireless communication system.

It should be understood by those skilled in the art that various modifications, combinations, sub-combinations and alterations may occur depending on design requirements and other factors insofar as they are within the scope of the appended claims or the equivalents thereof.

For example, in the above explanation, a configuration has been described as an example according to which audio data is streamed, but modification into a configuration according to which video data is streamed is also possible. Further, an explanation has been given keeping a wireless LAN based on IEEE 802.11 in mind, but use on wireless transmission technologies based on other wireless communication schemes is also possible. For example, use on technologies such as Bluetooth (registered trademark), a Wireless USB, and the like is also possible. Furthermore, an explanation has been given keeping timing control according to CSMA/CA in mind, but the technology of the present embodiment is effective also with respect to systems using other retransmission control technologies.

Furthermore, an explanation has been given keeping streaming in mind, but if the technology according to the present embodiment is taken as a technology of automatically setting desirable receiving sensitivity according to the environment, it can also be taken as an environment-adaptive throughput enhancement technology. In this manner, specific matters stated in the above explanation are not to limit the application scope of the present embodiment, but are described to help understand the technology. Accordingly, the application scope of the present embodiment should be understood in view of current and future technological practice.

What is claimed is:

1. A wireless communication apparatus comprising:
a filter for removing a signal whose strength is below a threshold;
a signal distinguishing unit for distinguishing between a non-interfering signal that is transmitted/received in a network that the wireless communication apparatus is connected to and an interfering signal that is transmitted/received in a network that the wireless communication apparatus is not connected to; and
a threshold adjustment unit for raising, in a case an interfering signal passed through the filter, the threshold to a level that causes the interfering signal to be removed by the filter.

2. The wireless communication apparatus according to claim 1, further comprising:
a signal transmission unit for transmitting, after adjustment of the threshold by the threshold adjustment unit, a signal to one or more other wireless communication apparatuses in the network that the wireless communication apparatus is connected to;
a signal reception unit for receiving a response signal transmitted from the one or more other wireless communication apparatuses in response to the signal transmitted by the signal transmission unit; and
a reception period prediction unit for predicting a period in which the response signal will be received by the signal reception unit,
wherein the threshold adjustment unit temporarily lowers the threshold only during the period predicted by the reception period prediction unit.

3. The wireless communication apparatus according to claim 1, further comprising:
a signal request unit for requesting, after adjustment of the threshold by the threshold adjustment unit, one or more other wireless communication apparatuses in the network that the wireless communication apparatus is connected to for transmission of a response signal; and
a channel change unit for changing a channel in a case the response signal is not received from at least one of the one or more other wireless communication apparatuses after the request by the signal request unit.

4. The wireless communication apparatus according to claim 1, further comprising:
a signal request unit for requesting, after adjustment of the threshold by the threshold adjustment unit, one or more other wireless communication apparatuses in the network that the wireless communication apparatus is connected to for transmission of a response signal,
wherein the threshold adjustment unit lowers the threshold in a case the response signal is not received from at least one of the one or more other wireless communication apparatuses after the request by the signal request unit.

5. The wireless communication apparatus according to claim 4,
wherein, in a case the response signal is not received from at least one of the one or more other wireless communication apparatuses after the request by the signal request unit, the threshold adjustment unit lowers the threshold step by step until the response signal is received from all of the one or more other wireless communication apparatuses.

6. The wireless communication apparatus according to claim 4, further comprising:
an information display unit for displaying identification information for identifying, in a case the response signal is not received from at least one of the one or more other wireless communication apparatuses after the request by the signal request unit, the at least one of the one or more other wireless communication apparatuses from which the response signal is not received.

7. The wireless communication apparatus according to claim 1,
wherein the non-interfering signal includes at least a video or audio that has been streamed.

8. A wireless communication system comprising:
a first wireless communication apparatus including
a first filter for removing a signal whose strength is below a first threshold,
a first signal distinguishing unit for distinguishing between a non-interfering signal that is transmitted/received in a network that the first wireless communication apparatus is connected to and an interfering signal that is transmitted/received in a network that the first wireless communication apparatus is not connected to, and
a first threshold adjustment unit for raising, in a case an interfering signal passed through the first filter, the first threshold to a level that causes the interfering signal to be removed by the first filter; and
a second wireless communication apparatus connected to the first wireless communication apparatus via the network, including
a second filter for removing a signal whose strength is below a second threshold,
a second signal distinguishing unit for distinguishing between a non-interfering signal that is transmitted/received in the network that the second wireless communication apparatus is connected to and an interfering signal that is transmitted/received in a network that the second wireless communication apparatus is not connected to, and
a second threshold adjustment unit for raising, in a case an interfering signal passed through the second filter, the second threshold to a level that causes the interfering signal to be removed by the second filter,
wherein the first wireless communication apparatus transmits a non-interfering signal including at least a video or audio that has been streamed, to the second wireless communication apparatus over the network.

9. A sensitivity adjustment method performed by a wireless communication apparatus including a filter for removing a signal whose strength is below a threshold, comprising:
distinguishing between a non-interfering signal that is transmitted/received in a network that the wireless communication apparatus is connected to and an interfering signal that is transmitted/received in a network that the wireless communication apparatus is not connected to; and
raising, in a case an interfering signal passed through the filter, the threshold to a level that causes the interfering signal to be removed by the filter.
